(19) United States
(12) Patent Application Publication
(10) Pub. No.: US 2010/0215451 A1
(43) Pub. Date: Aug. 26, 2010

(54) CUTTING TIP

(76) Inventor: Sung Haeng Jo, Seoul (KR)

Correspondence Address: CHRISTOPHER PAUL MITCHELL, 888 16TH ST., NW, SUITE 800, WASHINGTON, DC, 20006, US

(21) Appl. No.: 12/524,360

(22) PCT Filed: Jan. 16, 2008
(86) PCT No.: PCT/KR08/00264

§ 371 Date: Feb. 21, 2010

(30) Foreign Application Priority Data
Feb. 2, 2007 (KR) 10-2007-0011182

(51) Int. Cl. B23B 51/04; B23B 27/14

(52) U.S. Cl. 408/204; 407/118; 408/227; 419/11

(57) ABSTRACT

A cutting tip is coupled with a rotor, which operates in response to actuation of a motor, in order to cut or process a workpiece. The cutting tip includes a plurality of first cutting recesses formed in upper and lower edges of one face of the cutting tip, which comes in contact with the workpiece; and a plurality of second cutting recesses, alternating with the first cutting recesses in a plan view, the second cutting recesses having a conical shape. The first and second cutting recesses in the cutting tip can minimize the abrasion of the cutting tip when cutting workpiece, enhance cutting power, and increase lifetime.

### TECHNICAL FIELD

The present invention relates to a cutting tip coupled with a rotating body, which is driven by a motor, and more particularly, to a cutting tip for cutting or processing various types of hard and workpieces, such as metal, stones, gems, composite and moldings.

### BACKGROUND ART

In general, a cutting tip is made of an alloy body containing diamond particles. The alloy body containing diamond particles is a composite, which is made by sintering a ferrous metal powder together with a carbide powder. As is well known in the art, the alloy body containing diamond particles is used for tools for cutting or drilling metals and stones due to its very high hardness and excellent abrasion resistance.

A cutting tip of this type is welded to a rotor, which is coupled with a rotary shaft of a motor, and rotates in one direction in response to the actuation of the motor. The cutting tip coupled with the rotor is brought into contact with a workpiece to cut the same. Here, the cutting tip is also referred to as a “segment,” and the rotor is also referred to as a “shank.”

The shank is generally made of steel, and the cutting tip is fabricated by sintering a mixture of metal powder and diamond particles at a very high temperature and pressure. The cutting tip is generally made of a super-hard alloy, as mentioned above. However, the processes for manufacturing these elements are well known in the art, and thus will not be described further.

As shown in FIG. 1 of the accompanying drawings, a conventional cutting tip 10a has predetermined widths of inner and outer peripheries, which extend along the length thereof. In the cutting tip 10a, diamond particles are mixed in metal powder. As shown in FIG. 2, a cutting tip 10b has cutting edges 11 formed on the upper and lower edges thereof.

The cutting edges 11 may be arranged at the same interval in one direction, or may be shaped as a grid mesh.

Since the cutting tip 10a with the diamond particles mixed in the metal powder has drawbacks, such as poor cutting power and poor abrasion resistance, a cutting tip having the cutting edges 11 is generally provided these days.

However, the cutting edges 11 as provided above are easily broken due to the shape thereof. Accordingly, it is required to frequently replace a cutting tip 10, part of which is broken, or the rotor, having the cutting tip 10 coupled thereto.

There are thus problems in that the cutting tip 10a having an excellent lifetime has poor cutting power, whereas the cutting tip having excellent cutting power has a short lifetime.

### DISCLOSURE OF INVENTION

### Technical Problem

The present invention has been made to solve the foregoing problems with the prior art, and therefore the present invention provides a cutting tip, which is not only improved in cutting power for cutting or processing workpieces but is also increased in lifetime.

The present invention also provides a cutting tip, which can cut or drill workpieces with a minimized contact area.

### Technical Solution

According to an aspect of the present invention, there is provided a cutting tip coupled with a rotor, which operates in response to an actuation of a motor, in order to cut or process a workpiece. The cutting tip includes a plurality of first cutting recesses formed in upper and lower edges of one face of the cutting tip, which comes in contact with the workpiece; and a plurality of second cutting recesses alternating with the first cutting recesses in a plan view, the second cutting recesses having a conical shape.

In the cutting tip of the invention, the first cutting recesses have a semi-conical shape.

In the cutting tip of the invention, the first cutting recesses have an inverted U shape or a semi-circular shape in a plan view.

In the cutting tip of the invention, the first cutting recesses and the second cutting recesses are arranged in top and bottom faces of the cutting tip such that they are staggered relative to each other.

The cutting tip of the invention may further include a cutting opening formed in the face of the cutting tip, which comes into contact with the workpiece, or in a different face of the cutting tip, which is coupled with the rotor.

In the cutting tip of the invention, the rotor comprises a wheel, which is coupled with a rotary shaft of the motor, and a plurality of cutting tips is welded to outer peripheral portions of the rotor at a predetermined interval.

In the cutting tip of the invention, the rotor comprises a hollow cylinder, which is coupled, at the upper central portion, with a rotary shaft of the motor, and is opened at the lower end, and a plurality of the cutting tips is welded to lower end portions of the rotor at a predetermined interval.

According to another aspect of the present invention, there is provided a method of fabricating a cutting tip. The method includes steps of mixing metal powder and diamond particles; putting a mixture of the metal powder and the diamond particles into a mold and pressing the mixture using a conical press to form first and second cutting recesses therein; and heating the mixture to cure it, wherein the metal powder comprises, by weight, 90% to 95% of Co and 5% to 10% of Ag.

### BRIEF DESCRIPTION OF THE DRAWINGS

FIGS. 1 and 2 are perspective views illustrating conventional cutting tips;

FIG. 3 is a perspective view illustrating a cutting tip according to a first embodiment of the invention;

FIG. 4 is a front elevation view illustrating the cutting tip according to the first embodiment of the invention;

FIG. 5 is a perspective view illustrating a cutting tip according to a second embodiment of the invention;

FIG. 6 is a perspective view illustrating a cutting tip according to a third embodiment of the invention;

FIG. 7 is a plan view illustrating cutting tips of the invention, coupled with a rotor in the form of a wheel; and

FIG. 8 is a plan view illustrating cutting tips of the invention, coupled with a rotor in the form of a cylinder.

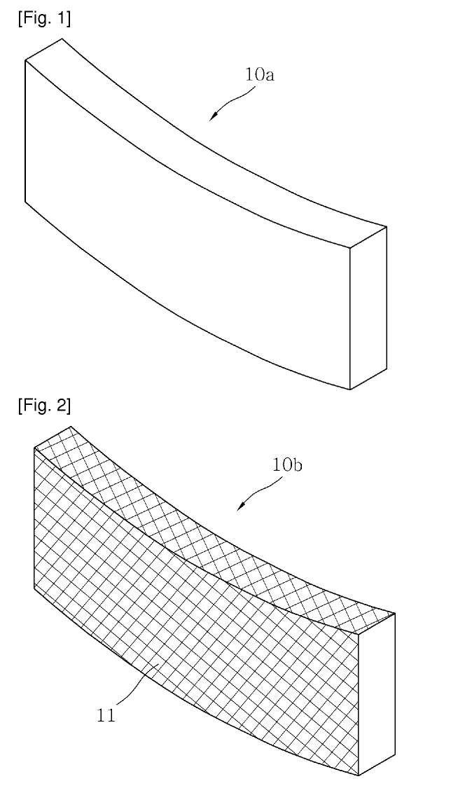

### MAJOR REFERENCE NUMERALS OF DRAWINGS

100, 200, 300: cutting tip 101, 201: inner periphery

102, 202: outer periphery

102a, 202a, 302a: upper edge

102b, 202b, 302b: lower edge

111a, 111b, 211a, 211b, 311: first cutting recess

112a, 112b, 212a, 212b, 312a, 312b: second cutting recess

120, 130: rotor 313: cutting opening

314: groove

### BEST MODE FOR CARRYING OUT THE INVENTION

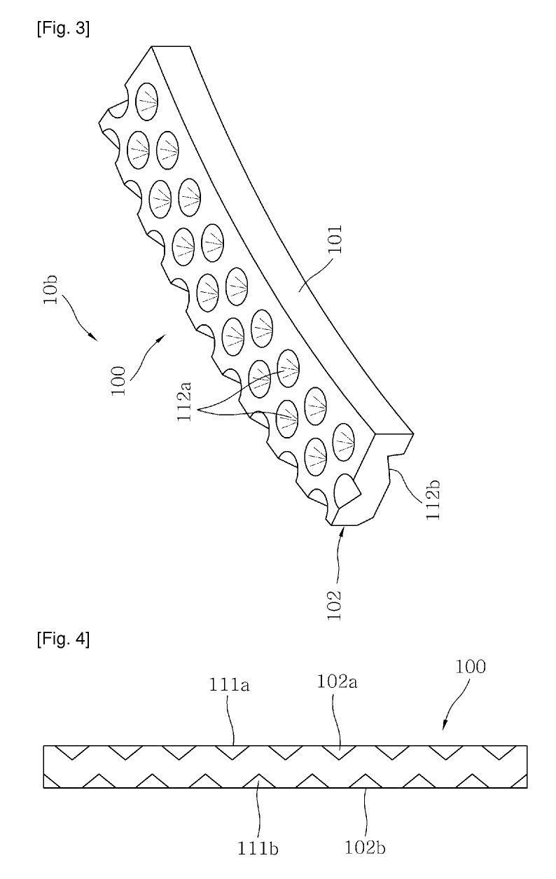

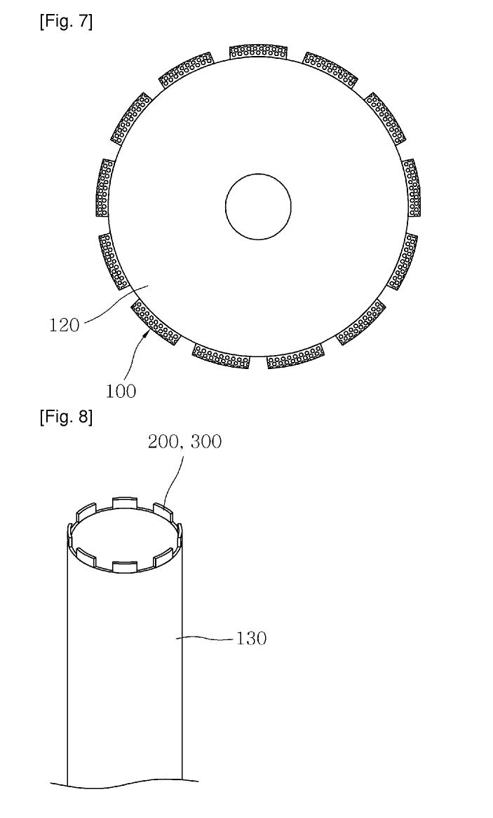

Hereinafter, with reference to FIGS. 3 to 8 of the accompanying drawings, the construction, the usages and the fabrication methods of cutting tips 100, 200 and 300 of the invention will be described.

First, the cutting tips 100, 200 are 300 are fabricated generally in two types according to the application, such as cutting workpieces using the cutting tip 100 and drilling workpieces using the cutting tips 200 and 300.

In the following description, the cutting tip 100 used for cutting workpieces corresponds to the first embodiment of the invention, whereas the cutting tips 200 and 300 for drilling workpieces correspond, respectively, to the second and third embodiments of the invention.

As shown in FIGS. 3 and 4, the cutting tip 100 of the first embodiment has arc-shaped inner and outer peripheries 101 and 102 to cut workpieces. That is, longitudinal edges of the cutting tip 100 are arc shaped. The cutting tip 100 has a width of about 1 cm and a length of about 2 cm to 5 cm.

The cutting tip 100 has first cutting recesses 111a and 111b and second cutting recesses 112a and 112b. The first cutting recesses 111a and 111b are formed, respectively, in the upper and lower edges 102a and 102b of the cutting tip 110, and the second cutting recesses 112a and 112b are formed, respectively, in the top and bottom faces of the cutting tip 100.

Here, the first cutting recesses 111a and 111b, in the form of a semi-conical shape, are continuously formed in the edges of the cutting tip. The first cutting recesses 111a in the upper edge 102a of the cutting tip 100 and the first cutting recesses 111b in the lower edge 102b of the cutting tip 100 are formed to alternate with each other. That is, the first cutting recesses 111a in the upper edge 102a are repeatedly formed in the shape of a “V,” and the first cutting recesses 111b in the lower edge 102b are repeatedly formed in the shape of an inverted V (Λ).

Accordingly, the first cutting recesses 111a and 111b in the upper and lower edges 102a and 102b have a shape of pyramidal waves, when seen from outside in a side elevation view.

A plurality of the second cutting recesses 112a and 112b is formed in the top and bottom faces of the cutting tip 100. Each of the second cutting recesses 112a and 112b has a conical shape. In the appended drawings, two rows of the second cutting recesses 112a are formed, one on each of the top and bottom faces of the cutting tip 100, respectively, continuously along the length thereof. Alternatively, 3 or 4 rows of second cutting recesses 112a and 112b may be provided.

Furthermore, in the second cutting recesses 112a and 112b, the first and second rows of the recesses 112a are staggered relative to each other. In addition, the second cutting recesses 112b in the upper face of the cutting tip 100 are staggered relative to the second cutting recesses in the bottom face of the cutting tip 100. That is, when the second cutting recesses 112a and 112b are cut in the longitudinal direction, the shape of the second cutting recesses 112a and 112b is the same as that of the first cutting recesses 111a and 111b.

A plurality of the cutting tips 100, configured as above, is coupled with the outer periphery or the outer circumference of a wheel type rotor 120, in which the cutting tips 100 are spaced apart from each other at a predetermined interval. Here, the cutting tips 100 are coupled with the rotor 120 via silver soldering.

Each of the cutting tips 100 is spaced apart from an adjacent one at an interval on the order of millimeters or centimeters.

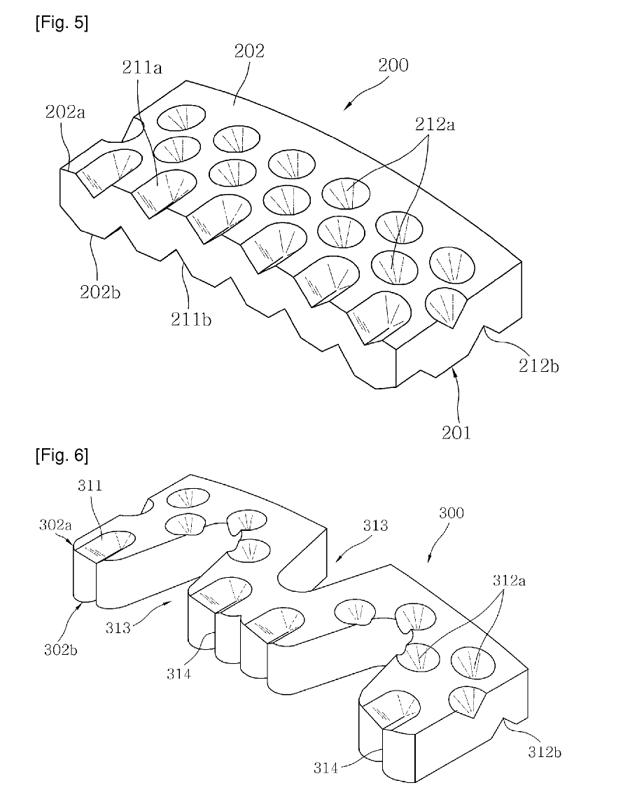

As shown in FIG. 5 the cutting tip 200 according to the second embodiment of the invention has arc-shaped top and bottom faces, and thus it can be used to drill workpieces.

That is, in view of the shape of the cutting tip 200 illustrated in the corresponding drawing, the top face acts as the outer periphery 201 and the bottom face acts as the inner periphery 202. The cutting tip 200 has an arc shape, with a uniform thickness defined between the top and bottom faces thereof. The cutting tip 200 also has first cutting recesses 211a and 211b and second cutting recesses 212a and 212b. The first cutting recesses 211a and 211b are formed, respectively, in the upper and lower edges 202a of the cutting tip 200, and the second cutting recesses 212a and 212b are formed, respectively, in the top and bottom faces of the cutting tip 200.

In the second embodiment, the first cutting recesses 211a and 211b and the second cutting recesses 212a and 212b have the same shape as in the first embodiment. Accordingly, the description of the first cutting recesses 211a and 211b and the second cutting recesses 212a and 212b of the cutting tip 200 of the second embodiment will refer to the foregoing description of the cutting tip 100 of the first embodiment.

As an alternative, the first cutting recesses 211a and 211b may have an inverted “U” shape (∩) when seen in a plan view.

As shown in FIG. 6, the cutting tip 300 according to the third embodiment of the invention has arc-shaped top and bottom faces, and thus it can be used to drill workpieces. That is, the arc-shape of the cutting tip 300 is substantially the same as that of the cutting tip 200 of the second embodiment.

The third cutting tip 300 has first cutting recesses 311, second cutting recesses 312a and 312b and openings 313. Here, the description of the first cutting recesses 311 and the second cutting recesses 312a and 312b of the cutting tip 200 of the third embodiment will refer to the foregoing corresponding description of the first and second embodiments. However, the second cutting recesses 312a and 312b may be formed only in the upper edge 302 of the cutting tip 300.

The cutting openings 313 are provided in front and rear parts of the cutting tip 300. The cutting openings 313 are formed by vertically cutting part of the cutting tip 300 from the top edge 302a to the bottom edge 302b or vice versa. When seen in a plan view, the cutting tip 300 has an “M” shape due to the cutting openings 313.

The front part of the cutting tip 300 is a face that contacts workpieces, whereas the rear part of the cutting tip 300 is a face that is coupled with the rotor.

Furthermore, a plurality of vertical grooves 314 is formed in the front face of the cutting tip 300. The grooves 314 are formed to pass through the central point of the first cutting recesses 311 and in positions between the first cutting recesses 311. The grooves 314 act to prevent the cutting tip 300 from breaking due to frictional heat, which is generated in the first cutting recesses 311 during the drilling of a workpiece.

The cutting tip 100, 200, 300 of the invention as set forth above is fabricated by sintering a mixture of metal powder and diamond particles. The sintering process of a super-hard alloy is well known in the art. In this invention, however, the metal powder contains, by weight, 90% to 95% of Co and 5% to 10% Ag.

In the process of fabricating the cutting tip 100, 200, 300 of the invention, after the metal powder is mixed with the diamond particles, the mixture is molded into a predetermined shape under a predetermined pressure. Here, the cutting tip 100, 200, 300 is pressed using a conical press, thereby forming the first cutting recesses 111a, 211a, 311 and the second cutting recesses 111b, 211b. The cutting openings 313 and the grooves 314 may be concurrently formed in this process, or may be formed later using a separate cutting machine.

Then, the sintered mixture is heated to realize the overall shape of the cutting tip 100, 200, 300. Next, the face of the cutting tip, which will be in contact with a rotor, is ground to remove foreign materials therefrom, and the cutting tip 100, 200, 300 is welded to the wheel type rotor 120 or the drilling rotor 130 via silver soldering or laser welding.

A plurality of the cutting tips 100 of the invention, realized according to the foregoing process, is coupled with the outer circumference of the wheel type rotor 120, and thus is used to cut workpieces, such as metal, stone, composites, moldings and hard substrates (or floors).

As shown in FIG. 8, a plurality of cutting tips 200, 300 of the invention is coupled with the cylindrical rotor 130. That is, the rotor 130 is coupled at the top central portion thereof with a rotary shaft of a motor, and the cutting tips 200, 300 are coupled with the bottom end of the rotor 130 and are spaced apart from each other at a predetermined interval.

Accordingly, the cutting tips 200, 300 can be used to drill workpieces, such as a wall or a hard substrate (or floor), the diameter of the drilled hole being determined by the diameter of the cylindrical rotor 130.

### INDUSTRIAL APPLICABILITY

As set forth above, the cutting tip of the invention can be used to cut or drill workpieces with minimal contact area with the workpieces. Furthermore, the conical recesses can be formed in the cutting tip, thereby enhancing the ability to cut workpieces.

Moreover, the cutting openings and the grooves in the cutting tip can facilitate the discharge of foreign materials which are generated when cutting or drilling workpieces.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A cutting tip coupled with a rotor, which operates in response to actuation of a motor, in order to cut or process a workpiece, the cutting tip comprising: a plurality of first cutting recesses formed in upper and lower edges of one face of the cutting tip, which comes in contact with the workpiece; and a plurality of second cutting recesses alternating with the first cutting recesses in a plan view, the second cutting recesses having a conical shape.

2. The cutting tip according to claim 1, wherein the first cutting recesses have a semi-conical shape.

3. The cutting tip according to claim 1, wherein the first cutting recesses have an inverted shape or a semi-circular shape in a plan view.

4. The cutting tip according to claim 1, wherein the first cutting recesses or the second cutting recesses are arranged in top and bottom faces of the cutting tip to such that they are staggered relative to each other.

5. The cutting tip according to claim 4, further comprising a cutting opening formed in the face of the cuffing tip, which comes into contact with the workpiece, or in a different face of the cutting tip, which is coupled with the rotor.

6. The cutting tip according to claim 1, wherein the rotor comprises a wheel, which is coupled with a rotary shaft of the motor, and wherein a plurality of the cutting tips is welded to outer peripheral portions of the rotor at a predetermined interval.

7. The cutting tip according to claim 1, wherein the rotor comprises a hollow cylinder, which is coupled, at an upper central portion, with a rotary shaft of the motor, and is opened at a lower end, and wherein a plurality of the cutting tips is welded to lower end portions of the rotor at a predetermined interval.

8. A method of fabricating a cutting tip, comprising: mixing metal powder and diamond particles; inputting a mixture of the metal powder and the diamond particles into a mold and pressing the mixture using a conical press to form first and second cutting recesses therein; and heating the mixture to cure, wherein the metal powder comprises, by weight, 90% to 95% of Co and 5% to 10% of Ag.
